(19) United States
(12) Patent Application Publication
(10) Pub. No.: US 2010/0020239 A1
(43) Pub. Date: Jan. 28, 2010

(54) DIGITAL PHOTO FRAME AND METHOD OF DISPLAYING DIGITAL PHOTOS THEREON

(75) Inventors: YI-FANG WU, Tu-Cheng (TW); YONG-HUI XIAO, Shenzhen City (CN); YUAN HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/470,414

(22) Filed: May 21, 2009

(30) Foreign Application Priority Data
Jul. 25, 2008 (CN) 200810303105.9

(51) Int. Cl. H04N 5/45

(52) U.S. Cl. 348/565

(57) ABSTRACT

A digital photo frame includes a display and a button. The display has a primary display area and a secondary display area. A digital photo can be displayed in the secondary display area. The primary display area can also display a first resized digital photo associated with the digital photo displayed on the secondary display area. The controls are capable of causing the digital photo on the secondary display area to display on the primary display area.

### BACKGROUND

1. Technical Field

The present disclosure relates to a digital photo frame and, particularly, to a digital photo frame with picture-in-picture.

2. Description of Related Art

Current digital photo frames can only display digital photos one by one in their entirety. A user cannot choose to view only a part of a digital photo.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a digital photo frame of the disclosure, showing a primary display area;

FIG. 2 is a schematic view of a digital photo frame of the disclosure, showing a secondary display area;

FIG. 3 is a schematic view of a digital photo frame of the disclosure, showing a menu;

FIG. 4 is a flow chart of a method of displaying digital photos on a digital photo frame;

FIG. 5 is a schematic view of a method of displaying digital photos on a digital photo frame, showing a whole digital photo on the primary display area; and

FIG. 6 is a schematic view of a method of displaying digital photos on a digital photo frame, showing a part digital photo on the primary display area.

### DETAILED DESCRIPTION

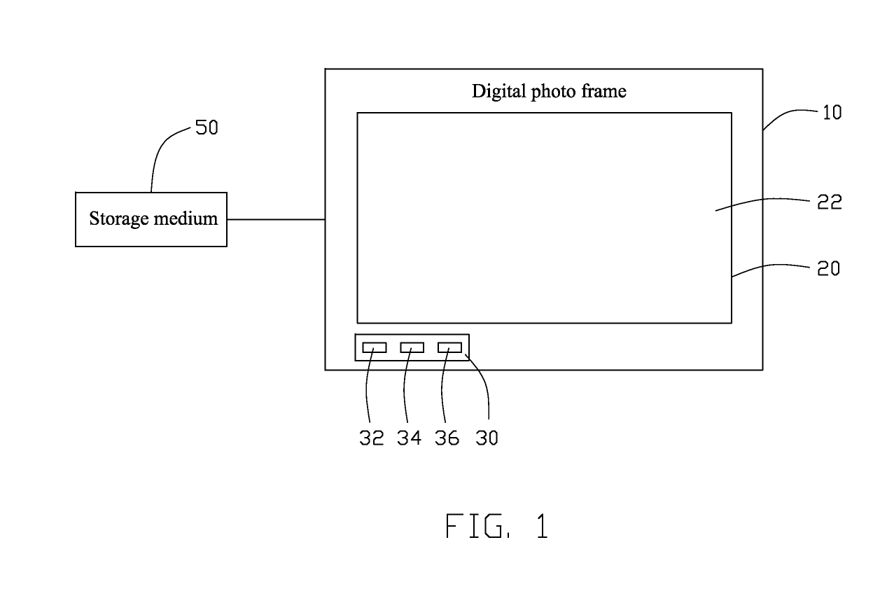

Referring to FIG. 1, a digital photo frame 10 of the disclosure includes a display 20 and a button area 30.

The digital photo frame 10 stores digital photos in a storage medium 50. The storage medium 50 may be internal, a memory card, a personal computer, or a network storage space. The digital photo frame 10 reads the digital photos from the memory card through a memory card reader therein and from the personal computer or the network storage space through a network.

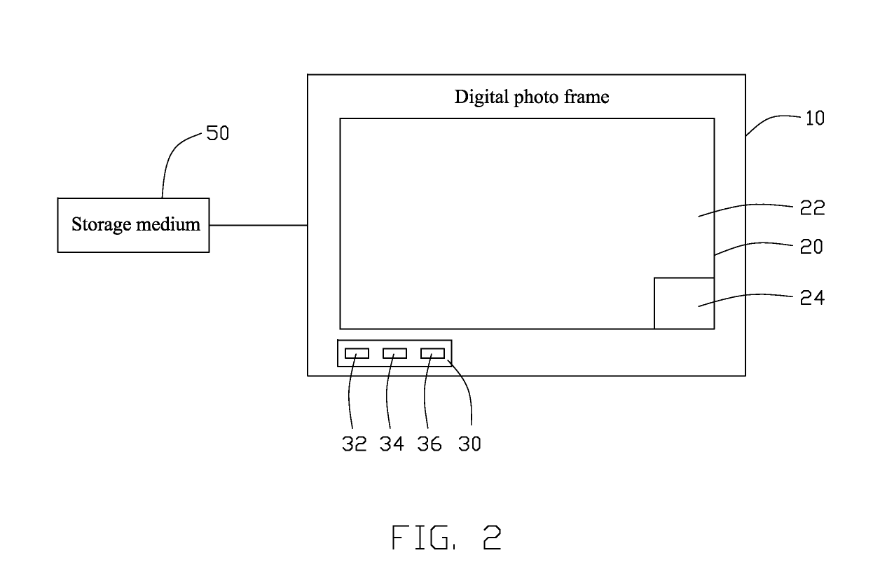

Referring to FIG. 2, the display 20 includes a primary display area 22 and a secondary display area 24. The primary display area 22 is used for displaying selected digital photos or parts of selected digital photos in the digital photo frame 10. The secondary display area 24 is used for displaying digital photos one by one.

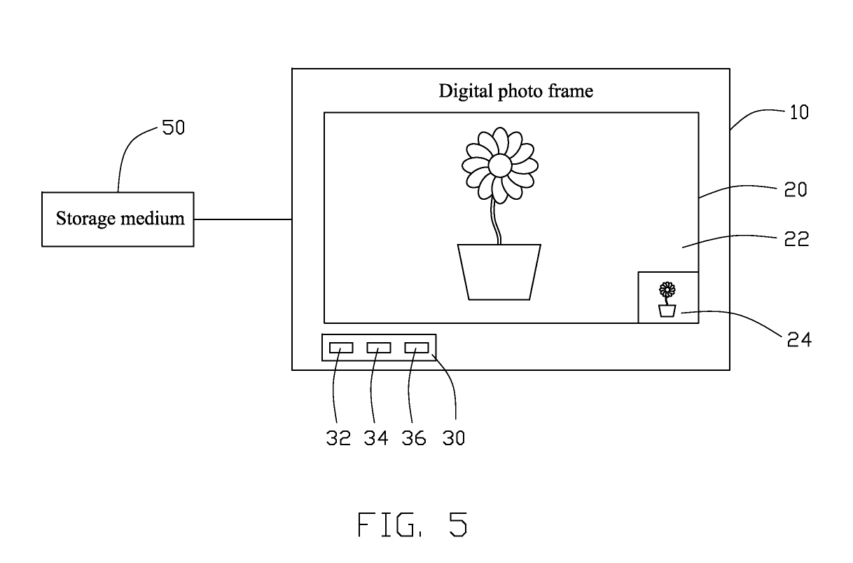

The button area 30 includes a selecting button 32, a direction button 34 and a zoom button 36. A first function of the selecting button 32 is to cause whatever is displayed in the secondary display area 24 to also be displayed in the primary display area 22. A second function of the selecting button 32 is that only the part of the digital photo surrounded by a cursor box 26 in the secondary display area 24 is displayed in the primary display area 22 (shown in FIG. 5). The direction button 34 can move the cursor box 26 in the secondary display area 24 up, down, left, and right. The direction button 24 can also be used to browse through the digital photos, on the photos being displayed one at a time in the secondary display area 24. The zoom button 36 is used for controlling a size of the cursor box 26.

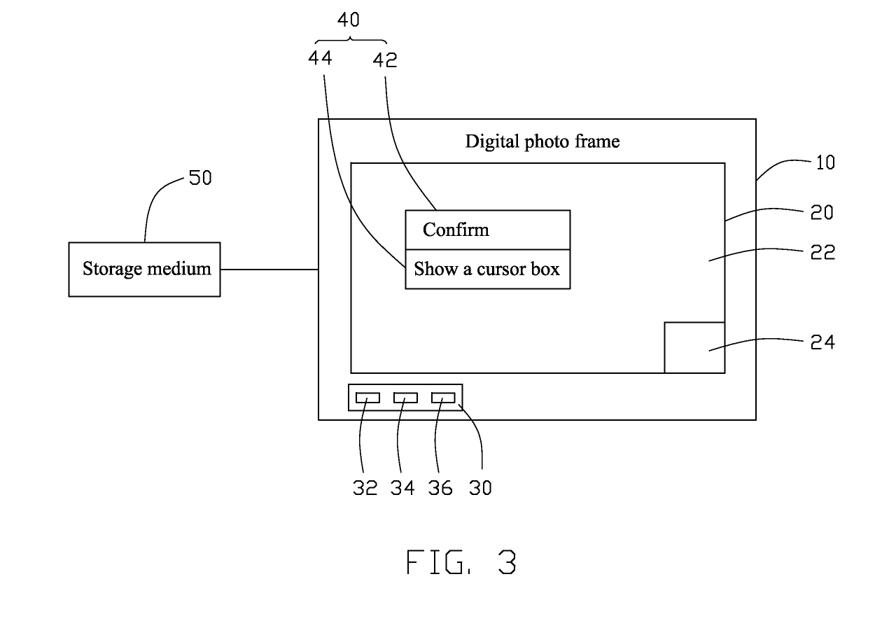

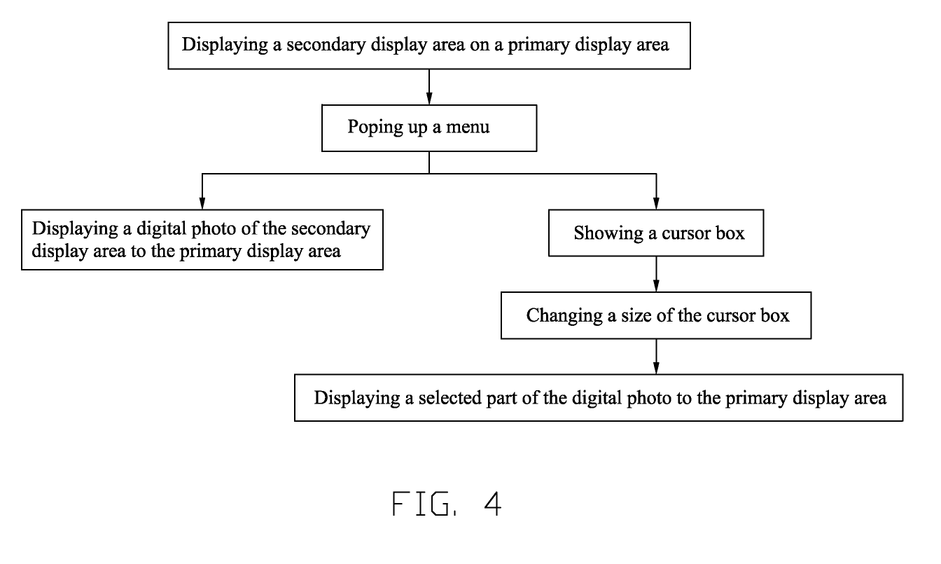

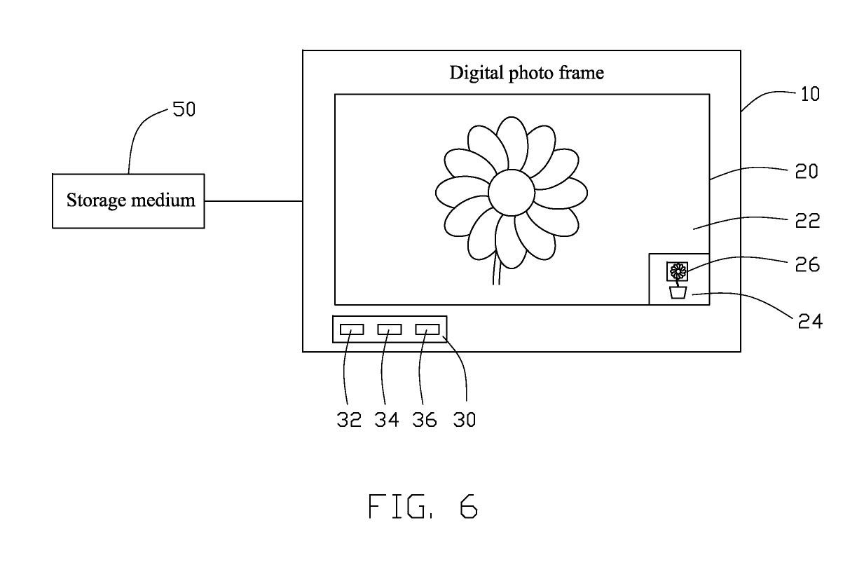

Referring to FIG. 3, FIG. 4, FIG. 5 and FIG. 6, the display 20 shows the primary display area 22. After the selecting button 32 is pressed, the secondary display area 24 is shown within the primary display area 22. At this time, the secondary display area 24 can display the digital photos in the digital photo frame 10 one by one. The direction button 34 can be used for browsing the digital photos in the secondary display area 24.

A user can press the selecting button 32 to have a digital photo currently in the secondary display area 24 displayed in the primary display area 22. At this time a menu 40 can pop up. The menu 40 includes a confirm option 42 and a show cursor box option 44. When the confirm option 42 is selected, the digital photo in the secondary display area 24 is displayed in the primary display area 22. The secondary display area 24 disappears from the display 20. When the show cursor box option 44 is selected, the cursor box 26 is shown in the secondary display area 24. The direction button 32 and the zoom button 36 can be used for choosing a part of the digital photo on the secondary display area 24. When the user has positioned the cursor box to their satisfaction they press the selecting button 32, and the part of the digital photo framed by the cursor box is displayed in the primary display area 22. Then the secondary display area 24 disappears from the display 20.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital photo frame comprising:
a display having a primary display area and a secondary display area, the secondary display area capable of displaying a digital photo, the primary display area being configured to display a first resized digital photo associated with the digital photo displayed in the secondary display; and
a button being capable of triggering the digital photo in the secondary display area to display in the primary display area.

2. The digital photo frame of claim 1, wherein the secondary display area has smaller size relative to the primary display area, and the secondary display area appears on the primary display area.

3. The digital photo frame of claim 1, wherein the secondary display area is capable of becoming part of the primary display area when the resized digital photo displayed in the primary display area.

4. The digital photo frame of claim 1, wherein the digital photo frame further comprises a selecting button, the selecting button is capable causing the secondary display area to appear in the display.

5. The digital photo frame of claim 1, wherein a cursor box is defined in the secondary display area, and the primary display area is capable of displaying a partial area of the digital photo that is displayed in the cursor box.

6. The digital photo frame of claim 5, wherein a selecting button is capable of causing a menu to appear, the menu comprises a show cursor box option for showing the cursor box on the secondary display area.

7. The digital photo frame of claim 5, wherein a direction button is arranged on the digital photo frame, and the direction button is capable of controlling the position of the cursor box on the secondary display area.

8. The digital photo frame of claim 7, wherein the secondary display area is capable of being used to browse two or more photos when the direction button is pressed.

9. The digital photo frame of claim 5, wherein a zoom button is capable of adjusting the size of the cursor box.

10. The digital photo frame of claim 5, wherein a selecting button is capable of displaying a selected part of the digital photo by the cursor box in the primary display area.

11. A method of displaying digital photos on a digital photo frame comprising:
defining a primary display area and a secondary display area on the digital photo frame; and
resizing a digital photo displayed on the secondary display area to fit in the primary display area at a first scale, and displaying the resized digital photo on the primary display area.

12. The method of displaying digital photos on a digital photo frame of claim 11, further comprising incorporating the secondary display area after the digital photo is displayed into the primary display area.

13. The method of displaying digital photos on a digital photo frame of claim 11, further comprising receiving input from a selecting button to display the secondary display area.

14. The method of displaying digital photos on a digital photo frame of claim 11, further comprising receiving input from a selecting button to display the whole digital photo to the primary display area.

15. The method of displaying digital photos on a digital photo frame of claim 11, further comprising resizing a partial area of the digital photo displayed on the secondary display area to fit in the primary display area.

16. The method of displaying digital photos on a digital photo frame of claim 15, further comprising selecting the partial area of the digital photo through a cursor box.

17. The method of displaying digital photos on a digital photo frame of claim 16, further comprising changing a size of the cursor box via a zoom button.

18. The method of displaying digital photos on a digital photo frame of claim 16, further comprising moving the cursor box via a direction button.

19. The method of displaying digital photos on a digital photo frame of claim 11, further comprising displaying the digital photos on the secondary display area in order by a direction button.

20. The method of displaying digital photos on a digital photo frame of claim 11, further comprising storing the digital photos in a storage medium.
